(19) United States
(12) Patent Application Publication
(10) Pub. No.: US 2005/0280251 A1
(43) Pub. Date: Dec. 22, 2005

(54) Inflator and airbag apparatus

(75) Inventors: Kanji Yano, Praunheim (DE); Jun Nishimura, Hikone-shi (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/151,284

(22) Filed: Jun. 14, 2005

(30) Foreign Application Priority Data
Jun. 22, 2004 (JP) 2004-183877

(51) Int. Cl. B60R 21/26

(52) U.S. Cl. 280/736

(57) ABSTRACT

A hybrid inflator includes a gas storage chamber filled with a pressurized gas, a chemical chamber filled with a gas generating chemical, and an initiator attached to the chemical chamber for igniting the chemical to generate a reaction gas. A gas outlet is formed to eject the pressurized gas and the reaction gas from the gas storage chamber, and a sealing plate is disposed in the gas storage chamber for separating the gas outlet from the gas storage chamber. A swirl forming device is disposed between the gas storage chamber and the chemical chamber for swirling the reaction gas from the chemical chamber and guiding the reaction gas into the gas storage chamber.

### BACKGROUND OF THE INVENTION AND RELATED ART STATEMENT

The present invention relates to an inflator, and in particular, to a hybrid inflator constructed to release a gas generated from a gas-generating chemical and a pressurized gas stored in a gas storage chamber. In addition, the present invention relates to an airbag apparatus provided with the inflator.

A hybrid inflator includes a gas-generating chemical ignited by an initiator and a pressurized gas storage chamber charged with a pressurized gas. When the chemical starts to react by the initiator, a reaction gas flows into the gas storage chamber. Then, the gas ruptures a sealing member separating the gas storage chamber and a gas outlet, and a mixed gas of a gas stored in the gas storage chamber (storage gas) and the reaction gas is released from the gas outlet.

Japanese Patent Publication (Kokai) No. 2003-226219 discloses an inflator that releases a reaction gas from a hole of a perforated cap and collides the reaction gas against an inner wall of a cylindrical gas storage chamber at one end thereof to stick combustion residues in the reaction gas to a chamber wall. A gas outlet is provided at the other end of the gas storage chamber.

Patent Document: Japanese Patent Publication (Kokai) No. 2003-226219

In the inflator disclosed in Japanese Patent Publication (Kokai) No. 2003-226219, the reaction gas generated by the reaction chemicals is not sufficiently mixed with the storage gas in the gas storage chamber. Specifically, when the chemicals start to react and the reaction gas flows into the gas storage chamber, the reaction gas tends to form a bulk portion at one end of the gas storage chamber. Accordingly, the storage gas is pushed and released by the bulk gas, and then the reaction gas is released. When the reaction gas is not sufficiently mixed with the storage gas, a temperature of the released gas becomes high when a gas containing the reaction gas is released. Therefore, an airbag is required to have heat-resistant to maintain strength enough to endure the high temperature gas upon contacting the high temperature gas.

Japanese Patent Publication (Kokai) No. 2003-226219 also discloses a configuration having no perforated cap. In this case, the gas released from the initiator flows straight into the gas storage chamber and reaches the gas outlet. Thus, the storage gas is not sufficiently mixed with the reaction gas, and the temperature of the released gas becomes high.

In view of the problems described above, an object of the present invention is to provide an inflator constructed to release a reaction gas generated by chemical after the reaction gas is sufficiently mixed with gas in a storage chamber.

Further objects ad advantages of the invention will be apparent from the following description of the invention.

### SUMMARY OF THE INVENTION

In order to attain the objects described above, according to the present invention, an inflator is a hybrid inflator comprising a gas storage chamber filled with pressurized gas; a chemical chamber filled with a gas-generating chemical; an initiator for igniting the chemical; a gas outlet; and a sealing plate for separating the gas outlet from the gas storage chamber. The chemical reacts to generate gas by the initiator, and the gas flows into the gas storage chamber and ruptures the sealing plate. Accordingly, the gas in the pressurized gas storage chamber and the gas generated from the chemicals are released from the gas outlet. The inflator further comprises a swirl forming device for swirling the gas generated from the chemical and flowing into the gas storage chamber.

According to the present invention, it is preferable that the swirl forming device is a guide member for guiding the gas to swirl.

According to the present invention, an airbag apparatus includes the inflator described above and an airbag expanded by the gas from the inflator.

In the present invention, the gas generated from the reaction of the chemical swirls and flows into the gas storage chamber. Thus, the reaction gas and the storage gas are sufficiently mixed with each other. Therefore, the temperature of the released gas becomes constant. As a result, heat resistance required for the airbag can be decreased.

The gas guide member with a simple configuration is suitable for the swirl forming device for swirling the gas.

### BRIEF DESCRIPTION OF THE DRAWING

FIGS. 1(a) to 1(e) are views showing an inflator according to an embodiment of the present invention, wherein FIG. 1(a) is a longitudinal sectional view, FIG. 1(b) is an enlarged cross-sectional view of a gas guide member taken along line 1(b)-1(b) in FIG. 1(c), FIG. 1(c) is a right side view of the gas guide member viewed from line 1(c)-1(c) in FIG. 1(b), FIG. 1(d) is a cross-sectional view taken along line 1(d)-1(d) in FIG. 1(c), and FIG. 1(e) is a cross-sectional view taken along line 1(e)-1(e) in FIG. 1(c);

FIGS. 2(a) to 2(c) are views showing a guide member in an inflator according to another embodiment of the present invention, wherein FIG. 2(a) is a cross-sectional view of the gas guide member taken along line 2(a)-2(a) in FIG. 2(b), FIG. 2(b) is a side view of the gas guide member viewed from line 2(b)-2(b) in FIG. 2(a), and FIG. 2(c) is a perspective view of the guide member;

FIGS. 3(a) and 3(b) are views showing a guide member in an inflator according to a further embodiment of the present invention, wherein FIG. 3(a) is a front view of the guide member viewed from line 3(a)-3(a) in FIG. 3(b), and FIG. 3(b) is a cross-sectional view thereof taken along line 3(b)-3(b) in FIG. 3(a); and

FIGS. 4(a) and 4(b) are views showing a guide member in an inflator according to a still further embodiment of the present invention, wherein FIG. 4(a) is a perspective view of the guide member, and FIG. 4(b) is a perspective view of semi-elliptic plates.

### DETAILED DESCRIPTION OF PREFERRED EMBODIMENTS

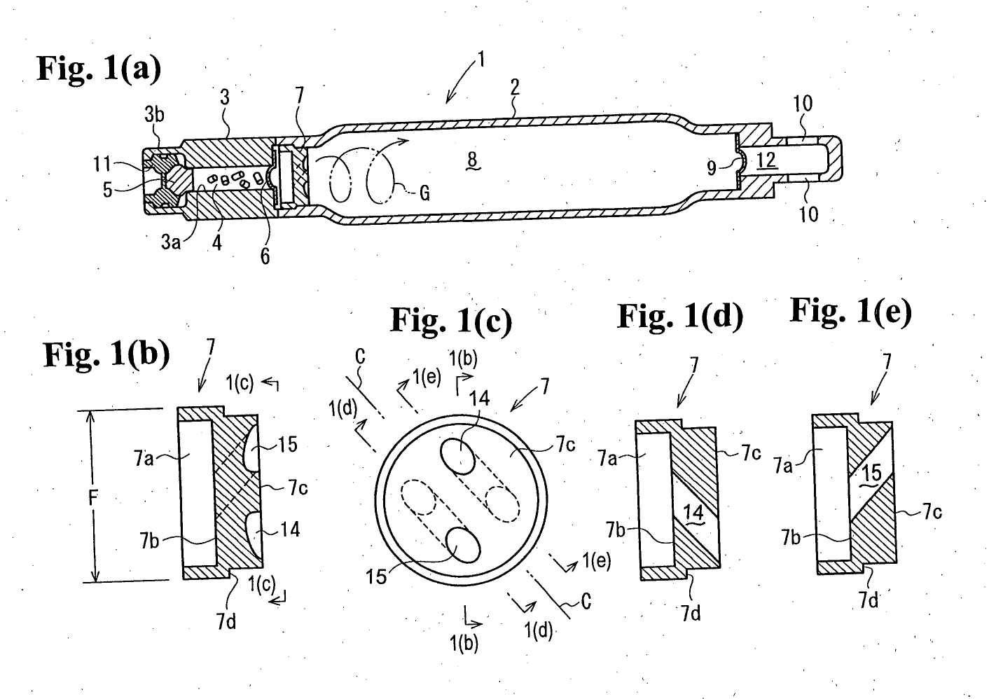

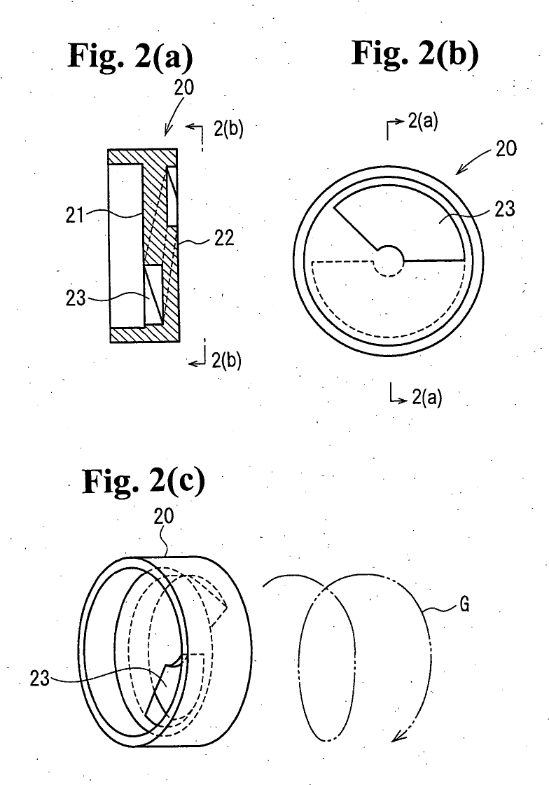

Hereinafter, embodiments of the present invention will be described with reference to the accompanying drawings. FIG. 1(a) is a longitudinal sectional view thereof; FIG. 1(b) is an enlarged cross-sectional view of a gas guide member taken along line 1(b)-1(b) in FIG. 1(c); FIG. 1(c) is a right side view of the gas guide member viewed from line. 1(c)-1(c) in FIG. 1(b); FIG. 1(d) is a cross-sectional view taken along line 1(d)-1(d) in FIG. 1(c); and FIG. 1(e) is a cross-sectional view taken along line 1(e)-1(e) in FIG. 1(c). FIGS. 2(a)-2(c) to 4(a)-4(b) show configurations of a guide member in an inflator according to embodiments, respectively.

As shown in FIG. 1(a), an inflator 1 comprises a substantially cylindrical pressure-proof vessel 2 (vessel); a head block 3 fixed at one end of the vessel 2; gas-generating chemicals 4 charged in the head block 3, an initiator 5 for igniting the chemicals 4; a first sealing plate 6 separating the interior of the head block 3 from one end of a gas storage chamber 8; a guide member 7 as a swirl forming device; and a second sealing plate 9 separating the other end of the gas storage chamber 8 from a gas outlet 10.

The vessel 2 is made of steel and the like, and the gas storage chamber 8 is charged with a gas, for example, nitrogen, argon, or helium at a pressure of 10,000 to 70,000 kPa. The head block 3 made of steel and the like is fixed to one end of the vessel 2 by welding. The head block 3 has a thick cylindrical shape, and an inner hole 3a as a chemical chamber is charged with the chemicals 4. A portion of the inner hole 3a at the vessel 2 side is sealed by the first sealing plate 6.

The first sealing plate 6 is made of, for example, a stainless sheet, and is fixed to the end surface of the head block 3 at the vessel 2 side by welding. The first sealing plate 6 is provided with a substantially hemispheric bulging portion entering the inner hole 3a to endure the pressure of gas from the gas storage chamber 8. The bulging portion may be provided with a rupture-promoting groove.

The initiator 5 is disposed to face a portion of the inner hole 3a opposite to the vessel 2. The initiator 5 includes igniting chemicals and an ignition device such as a resistance heating element for igniting the igniting chemicals. In the initiator 5, when power is applied to the ignition device, the igniting chemicals react to generate a high-temperature gas. The initiator 5 is held in an end sleeve 3b of the head block 3 by an initiator holder 11.

The other end of the vessel 2 is provided with a guide hole 12, and the gas outlet 10 is disposed at the end of the guide hole 12. The second sealing plate 9 is provided so as to seal the inflow end of the guide hole 12. A hemispheric bulging portion provided at the second sealing plate 9 enters the guide hole 12. The sealing plate 9 is fixed to the circumferential edge of the inflow end of the guide hole 12. The gas storage chamber 8 is formed between the sealing plates 6 and 9. A filter (not shown) may be provided in the guide hole 12 to collect combustion residues of the chemicals 4.

Next, a configuration of the guide member 7 will be described with reference to FIGS. 1(b) to 1(e). The guide member 7 is substantially disc-shaped, and a circular recessed part 7a is formed in a surface of the guide member 7 facing the first sealing plate 6. Two nozzles 14 and 15 are provided for communicating a bottom surface 7b of the recessed part 7a with a rear surface 7c of the guide member 7. The respective nozzles 14 and 15 extend linearly, and their axes have a twisted relationship to each other.

The nozzle 14 is located at one half with respect to a plane (a plane taken along C-C line in FIG. 1(c)) passing through both the nozzles 14 and 15 and including the axis of the disc-shaped guide member 7. The nozzle 15 is located at the other half with respect to the plane. With the nozzles 14 and 15 thus arranged, the gas passing through the nozzles 14 and 15 forms a swirl like an arrow G in FIG. 1(a).

An operation of the inflator constructed as described above is as follows. When the initiator 5 is supplied with power, the initiator 5 generates a high-temperature gas, and then a large amount of reaction gas is generated by the chemicals 4 contacting the high-temperature gas. The pressure of the high-temperature gas ruptures the first sealing plate 6, and the reaction gas passes through the nozzles 14 and 15 of the guide member 7 and flows into the gas storage chamber 8 while forming a swirl G. As the gas pressure of the gas storage chamber 8 increases, the second sealing plate 9 is ruptured, and the gas is released from the guide hole 12 via the gas outlet 10. Then, the gas rapidly expands an airbag.

In the inflator 1, the reaction gas of the chemicals 4 forms a swirl G. Accordingly, the reaction gas is sufficiently mixed with the storage gas and released from the gas outlet 10. Therefore, the temperature of the releasing-gas is almost constant. That is, the hot reaction gas is not localized and released from the gas outlet 10. Therefore, the airbag expanded by the inflator 1 does not, need to have high heat resistance.

Other examples of guide members that can be used in the inflator of the present invention will be described with reference to FIGS. 2(a)-2(c) to 4(a)-4 (b). A guide member 20 shown in FIGS. 2(a)-2(c) is substantially disc-shaped, and a spiral nozzle 23 is provided to communicate one face 21 of the guide member 20 with the other face 22 thereof. The gas passes through the spiral nozzle 23 disposed in the vessel, thereby forming a swirl G as shown in FIG. 2(c). FIG. 2(a) is a cross-sectional view of the guide member 20 taken along an axis thereof and line 2(a)-2(a) in FIG. 2(b). FIG. 2(b) is a view seen from line 2(b)-2(b) in FIG. 2(a), and FIG. 2(c) is a perspective view of the guide member 20.

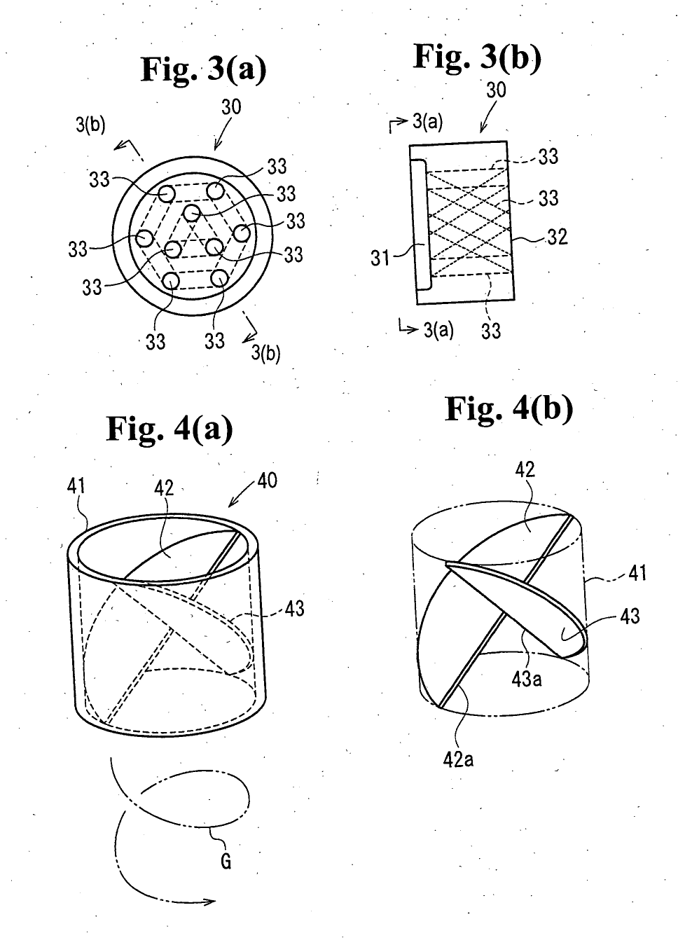

As shown in FIGS. 3(a) and 3(b), a guide member 30 includes a lot of nozzles 33 (nine nozzles in the figure). Each nozzle 33 communicates a face 31 of the substantially disc-shaped guide member 30 with a face 32 thereof. Every nozzle 33 is inclined in the same direction around the axis of the guide member 30. The gas passes through the nozzles 33 of the guide member 30 disposed in the vessel 2, thereby forming a swirl. FIG. 3(a) is a front view of the guide member 30 viewed from line 3(a)-3(a) in FIG. 3(b), and FIG. 3(b) is a cross-sectional view thereof taken along line 3(b)-3(b) in FIG. 3(a). In order to make the configuration clear, the hatching of the cross-section is omitted in FIG. 3(b).

As shown in FIG. 4, a guide member 40 includes two pieces of semi-elliptic plates 42 and 43 in a cylindrical casing 41. The circumferential edges of the semi-elliptic plates 42 and 43 touch the inner circumferential face of the casing 41 and are fixed thereto by welding. Chords 42a and 43a of the semi-elliptic plates 42 and 43 are connected to each other at their longitudinal intermediate portions. The plate faces of the semi-elliptic plates 42 and 43 intersect each other. The gas passes through the guide member 40 disposed in the vessel 2, thereby forming a swirl G as shown in FIG. 4(a). FIG. 4(a) is a perspective view of the guide member 40, and FIG. 4(b) is a perspective view of the semi-elliptic plates 42 and 43.

The embodiments described above are just examples of the present invention, and the present invention can be modified from those illustrated in the drawings. For example, the guide member 7 is disposed in the vessel 2 in the embodiment, and a guide bane for forming a swirl may be provided at the inner circumferential edge of the vessel 2.

The inflator of the present invention can be applied to various kinds of airbag apparatus such as those for a front passenger, a head-protection, a knee-protection, a driver, and a rear passenger.

The disclosure of Japanese Patent Application No. 2004-183877, filed on Jun. 22, 2004, is incorporated in the application.

While the invention has been explained with reference to the specific embodiments of the invention, the explanation is illustrative and the invention is limited only by the appended claims.

1. A hybrid inflator comprising:
a gas storage chamber filled with a pressurized gas,
a chemical chamber filled with a gas-generating chemical and located next to the gas storage chamber,
an initiator attached to the chemical chamber for igniting the chemical to generate a reaction gas,
a gas outlet attached to the gas storage chamber for ejecting the pressurized gas and the reaction gas from the gas storage chamber,
a sealing plate disposed in the gas storage chamber for separating the gas outlet from the gas storage chamber, and
a swirl forming device disposed between the gas storage chamber and the chemical chamber for swirling the reaction gas from the chemical chamber and guiding the reaction gas into the gas storage chamber.

2. An inflator according to claim 1, wherein said swirl forming device includes a guide member for guiding the reaction gas to swirl.

3. An inflator according to claim 2, wherein said guide member includes at least one hole communicating between the gas storage chamber and the chemical chamber, said at least one hole being inclined relative to a longitudinal direction of the gas storage chamber so that the reaction gas passes through the hole while swirling.

4. An inflator according to claim 2, wherein said guide member is a plate for guiding the reaction gas from the chemical chamber to the gas storage chamber, said plate being inclined relative to a longitudinal direction of the gas storage chamber so that the plate guides the reaction gas to swirl.

5. An inflator according to claim 1, further comprising another sealing plate situated between the swirl forming device and the chemical chamber, said swirl forming device being disposed in the gas storage chamber.

6. An airbag apparatus comprising the inflator according to claim 1, and an airbag to be inflated by the inflator.
